(19) United States
(12) Patent Application Publication
(10) Pub. No.: US 2022/0253723 A1
(43) Pub. Date: Aug. 11, 2022

(54) AMPLIFYING SOURCE CODE SIGNALS FOR MACHINE LEARNING

(71) Applicant: International Business Machines Corporation, Armonk, NY (US)

(72) Inventors: Julian Timothy Dolby, Bronx, NY (US); MARTIN HIRZEL, Ossining, NY (US); Kiran A. Kate, Chappaqua, NY (US); Louis Mandel, New York, NY (US); Avraham Ever Shinnar, Westchester, NY (US); Kavitha Srinivas, Port Chester, NY (US); Jason Tsay, White Plains, NY (US)

(21) Appl. No.: 17/172,231

(22) Filed: Feb. 10, 2021

(51) Int. Cl. G06N 5/04; G06N 20/00; G06F 8/72; G06F 8/41

(52) U.S. Cl. CPC G06N 5/04; G06F 8/443; G06F 8/72; G06N 20/00

(57) ABSTRACT

Embodiments are disclosed for a method. The method includes identifying one or more source code signals in a source code. The method also include generating an amplified code based on the identified signals and the source code. The amplified code is functionally equivalent to the source code. Further, the amplified code includes one or more amplified signals. The method additionally includes providing the amplified code for a machine learning model that is trained to perform a source code relevant task.

### BACKGROUND

The present disclosure relates to amplifying source code signals, and more specifically, to amplifying source code signals for machine learning.

Computer software can be written as code, more specifically, program source code in a programming language such as Java, Python, C++, and so on. Machine learning (ML) models can be trained for several tasks on source code. For instance, ML models can find potential bugs in code; they can compare code snippets for similarity; they can predict how fast code will run; and, various other tasks. For these tasks, the training data for the ML model includes code examples.

It is useful to train ML models for source code tasks such that their predictions are relatively accurate, the ML models are effective at their task, and make relatively few mistakes. In order to make such predictions, an ML model can identify signals in the code (source code signals) that are useful for training or scoring. Source code signals can include concepts in software coding, such as, syntax (the grammar of the programming language), scopes (which names in the code are visible where), types (such as integer, string, list, etc.), data flow, control flow, and the like.

One machine learning technique for training models in source code relevant tasks involves a statistical approach, where the machine learning model tries to learn how to identify source code signals, and uses the identified signals to train for the relevant task. However, using this approach, the trained ML model may not be useful without learning how to reliably identify source code signals. Further, this approach can involve relatively large amounts of training data and time.

### SUMMARY

Embodiments are disclosed for a method. The method includes identifying one or more source code signals in a source code. The method also includes generating an amplified code based on the identified signals and the source code. The amplified code is functionally equivalent to the source code. Further, the amplified code includes one or more amplified signals. The method additionally includes providing the amplified code for a machine learning model that is trained to perform a source code relevant task. Advantageously, such embodiments are useful for increasing the efficiency of training machine learning models to perform source code relevant tasks.

Optionally, in some embodiments, the method further includes determining a loss of the machine learning model using a loss function. Additionally, the method includes selecting one or more source code signal categories for amplification. The method also includes selecting one or more of the source code signal categories for de-amplification. Further, the method includes identifying the one or more source code signals based on the selected source code signal categories. Advantageously, such embodiments are useful for increasing the efficiency of training machine learning models to learn source code relevant tasks.

An additional embodiment is disclosed for a method. The method includes identifying one or more source code signals in a source code. Further, the method includes generating one or more amplified versions of the source code based on the identified signals and the source code. The amplified versions of the source code are functionally equivalent to the source code. Also, the amplified versions of the source code comprise one or more amplified signals. The method further includes training a machine learning model to perform a source code relevant task using the source code and the amplified versions of the source code. Advantageously, such embodiments are useful for increasing the efficiency of training machine learning models to learn source code relevant tasks.

An additional embodiment is disclosed for a method. The method includes identifying one or more source code signals in a source code. The method further includes generating a one or more amplified versions of the source code based on the identified signals and the source code. The amplified versions of the source code are functionally equivalent to the source code. Also, the amplified versions of the source code comprise one or more amplified signals. The method additionally includes generating one or more negative versions based on the source code. Further, the method includes training a machine learning model to perform a source code relevant task using the source code, the amplified versions, and the negative versions. Advantageously, such embodiments are useful for increasing the efficiency of training machine learning models to learn source code relevant tasks.

Further aspects of the present disclosure are directed toward systems and computer program products with functionality similar to the functionality discussed above regarding the computer-implemented methods. The present summary is not intended to illustrate each aspect of, every implementation of, and/or every embodiment of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram of an example system for amplifying source code signals for machine learning, in accordance with some embodiments of the present disclosure.

FIG. 2 is a data flow diagram of an example system for amplifying source code signals for machine learning, in accordance with some embodiments of the present disclosure.

FIG. 3 is a data flow diagram for an example system for amplifying source code signals with automatic tuning, in accordance with some embodiments of the present disclosure.

FIG. 4 is a data flow diagram of an example system for amplifying source code signals for machine learning, in accordance with some embodiments of the present disclosure.

FIG. 5 is a data flow diagram of an example system for amplifying source code signals for machine learning, in accordance with some embodiments of the present disclosure.

FIG. 6 is a process flow diagram of an example method for amplifying source code signals for machine learning, in accordance with some embodiments of the present disclosure.

FIG. 7 is a process flow diagram of an example method for amplifying source code signals for machine learning, in accordance with some embodiments of the present disclosure.

FIG. 8 is a block diagram of an example signal amplifier, in accordance with some embodiments of the present disclosure.

FIG. 9 is a cloud computing environment, in accordance with some embodiments of the present disclosure.

FIG. 10 is a set of functional abstraction model layers provided by the cloud computing environment, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

As stated previously, machine learning (ML) models can be trained for several tasks on source code, examples of which can be used as training data for ML models. Further, training machine learning models for source code relevant tasks involves a statistical approach, which may not be useful without learning how to reliably identify source code signals. Additionally, this approach can involve relatively large amounts of training data and time.

Accordingly, embodiments of the present disclosure can provide a signal amplifier that modifies source code before the ML model trains on it. Modifying the source code in this way can make the source code signals easier for the ML model to identify. In this way, embodiments of the present disclosure can improve the efficiency of training ML models for source code relevant tasks, and making those ML models more reliable. Some embodiments of the present disclosure can work with a large variety of ML models, including but not limited to, various neural network architectures. This is because the rewritten code is still valid with respect to the programming language, making it well-formed input for an off-the-shelf ML model. Hence, embodiments of the present disclosure can be applied without making any changes to the ML model architectures or objectives.

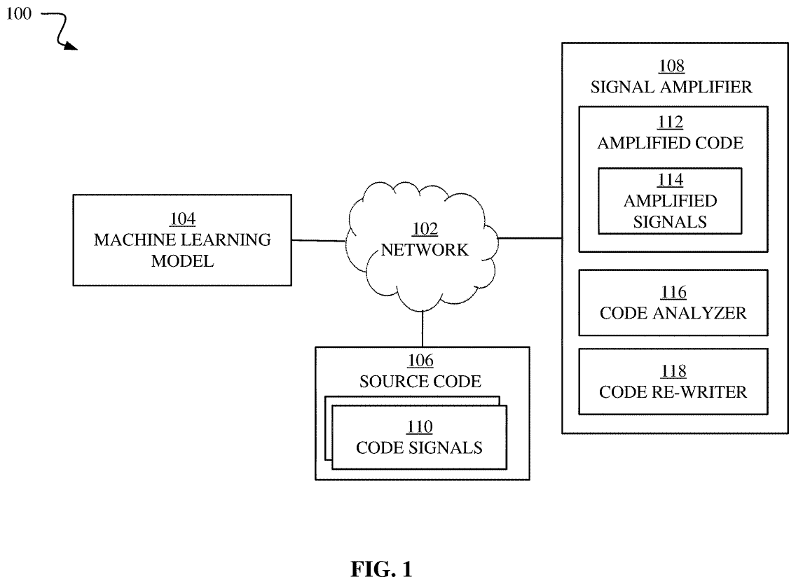

FIG. 1 is a block diagram of an example system 100 for amplifying source code signals for machine learning, in accordance with some embodiments of the present disclosure. The system 100 includes a network 102, machine learning model 104, source code 106, and signal amplifier 108. The network 102 may be a local area network, wide area network, or collection of computer communication networks that facilitates communication between components of the system 100, specifically, between the machine learning model 104, source code 106, and signal amplifier 108. In some embodiments, the network 102 can be the Internet.

The machine learning model 104 can be a software tool that learns how to perform specific tasks based on a training process and thus, performs the learned tasks. More specifically, the machine learning model 104 is trained to perform, and performs, source code related tasks using the source code 106. For example, the machine learning model 104 can find potential bugs, compare different code examples for similarity, predict how fast code runs, and so on. The machine learning model 104 can include off-the-shelf machine learning models for source code related tasks. Such machine learning models may have a variety of tasks, e.g., to find bugs, repair bugs, measure code similarity, perform code completion, and the like.

The source code 106 can be computer instructions coded in third generation programming languages, such as, Java, Python, C++, and so on. The source code 106 can include one or more code signals 110. The code signals 110 can be segments of the source code 106 associated with computer programming concepts that are useful for performing source code related tasks. These concepts can include, but are not limited to, syntax, scopes, types, data/control flow, and the like. In some embodiments of the present disclosure, the source code signals 110 can be useful for training the machine learning model 104 to perform source code related tasks. Additionally, the source code signals 110 can be useful for the machine learning model 104 to score source code 106 in source code related tasks.

The signal amplifier 108 can take a source code 106 for input, and generate amplified code 112 that is functionally equivalent to the input source code 106. Additionally, the amplified code 112 can include amplified signals 114. The amplified signals 114 can be functionally equivalent to corresponding source code signals 110 in the input source code 106. Further, the amplified signals 114 can be more obvious to the machine learning model 104 for the purpose of source code signal identification. According to some embodiments of the present disclosure, the signal amplifier 108 can generate the amplified code 112 without changes to the machine learning model's architecture or objective. Thus, while different code signals 110 may be useful for different source code related tasks, the signal amplifier 108 is useful for machine learning models 104 that perform any type of source code related task that uses code signals 110.

The signal amplifier 108 includes a code analyzer 116 and a code re-writer 118. The code analyzer 116 can analyze the input source code 106 to identify the source code signals 110. In some embodiments of the present disclosure, the code analyzer 116 can use established techniques from programming language compiler front-ends. For example, the code analyzer 116 can start by treating the source code 106 as a plain character sequence. Further, the code analyzer 116 can incorporate a lexer, also known as lexical analyzer, to generate a sequence of tokens from the character sequence. The tokens can include keywords, identifiers, numeric literals, operators, punctuation, and the like. Further, the code analyzer 116 can use a parser, also known as syntax analyzer, to generate a parse tree or an abstract syntax tree (AST) from the sequence of tokens. This AST can identify code signals for syntax. Additionally, the code analyzer 106 can use various forms of semantic analyzers to identify other types of code signals 110. Additionally, the code analyzer can include analyzers such as used by a compiler front-end, to identify code signals 110 for scope and types. Also, more sophisticated compilers can also analyze data flow and control flow, which again can serve as signals. Accordingly, the code analyzer can incorporate such techniques to identify data and/or control flow.

Further, the code re-writer 118 uses the identified signals to rewrite the original input source code 106 into the amplified code 112. The amplified code 112 includes amplified signals 114, which can be source code that is functionally equivalent to corresponding code signals 110 in the source code 106. Additionally, the amplified signals 114 can help the machine learning model 104 identify the code signals 110. In this way, the machine learning model 104 can use the amplified code 112 as training data or test data instead of the original input source code 106. In some embodiments of the present disclosure, the amplified code 112 can include production traffic.

Below, TABLES 1 through 4 include examples of input and amplified Java source code for respective signal categories: syntax, scope, types, and data flow. Each of TABLES 1 through 4 include columns labeled, signal category, original, and amplified. The original and amplified columns reference respective source code 106 and amplified code 112, e.g., before and after examples of Java source code. While the given examples are in the Java programming language, the signal amplifier 108 can amplify code signals 110 in various other programming languages.

TABLE 1

| SIGNAL | | |
|---|---|---|
| CATEGORY | ORIGINAL | AMPLIFIED |
| SYNTAX | if (x ∥ y == false) | if (x ∥ (y == false)) |
| | return ‘A’; | return ‘A’; |
| | return ‘B’; | return ‘B’; |

In TABLE 1, the signal category is syntax. Thus, the original code can be relevant to one or more rules of syntax. More specifically, the meaning of the expression “(x∥y==false),” in the original code, depends on the syntax of operator precedence. Operator precedence determines the sequence in which various logical and/or arithmetic operators are applied. According to operator precedence, the “==” operator can have higher precedence than the “∥” operator. Thus, to help the machine learning model 104 interpret, “(x∥y==false),” accurately, the code re-writer 118 can amplify this code signal by adding parentheses as shown in the amplified code, “(y==false).” In this way, the signal amplifier 108 makes it easier for the machine learning model 104 to identify the correct operator precedence.

In TABLE 2, the signal category is scope. The scope can define a functional state within which a variable can be referenced.

TABLE 2

| SIGNAL | | |
|---|---|---|
| CATEGORY | ORIGINAL | AMPLIFIED |
| SCOPE | x = 5; | x = 5; |
| | { int x = 10; } | { int x2 = 10; } |
| | if (x == 5) return ‘A’; | if (x == 5) return ‘A’; |
| | return ‘B’; | return ‘B’; |

As shown, the original code includes multiple definitions of the variable, x, with differing scopes. Accordingly, the meaning of the expression, “x==5,” in the original code, depends on understanding which definition of x is in scope. In this example, the first x defined is in scope, and the second definition is out of scope. As such, the code amplifier 108 can amplify the scope of x in the, “x==5,” expression by renaming the second definition from “x” to “x2.” In this way, the signal amplifier 108 makes it easier for the machine learning model 104 to identify the scope accurately. Scope can also represent a binding between a function and its variables. In this context, the signal amplifier 108 makes it easier for the machine learning model 104 to identify the correct binding.

In TABLE 3, the signal category is types. The types can define what type of data a variable holds, and how a computer processor handles operations on this data.

TABLE 3

| SIGNAL | | |
|---|---|---|
| CATEGORY | ORIGINAL | AMPLIFIED |
| TYPES | var x = 3.0; | var x = 3.0; |
| | if (x / 2 == 1.5) | if ((double)x / 2 == 1.5) |
| | return ‘A’; | return ‘A’; |
| | return ‘B’; | return ‘B’; |

In TABLE 3, the meaning of expression, “x/2,” in the original code depends on understanding the variable type of x. More specifically, the meaning of this expression can change depending if the variable type of x is a double precision floating number (for decimal values) or an integer (for whole numbers). The division operator, “/,” can produce decimal values, and thus loses information if the variable is an integer type. Thus, to help the machine learning model 104 interpret the, “x/2,” expression correctly, the signal amplifier 108 can amplify the types signal in the original code to show that the x variable is of type, double. More specifically, the amplified code can include an express variable type specification, also referred to as a cast. Thus, the signal amplifier 108 can add a type cast, “(double)x/2.” In this way, the signal amplifier 108 can make it easier for the machine learning model 108 to identify the correct type for variable, x, in the “x/2” expression.

In TABLE 4, the signal category is data flow. The data flow can represent how data values propagate between variables and expressions during program execution.

TABLE 4

| SIGNAL | | |
|---|---|---|
| CATEGORY | ORIGINAL | AMPLIFIED |
| DATA FLOW | int x = 2; | int x2 = 2; int x5; |
| | if (flag) | if (flag) |
| | x = 3; | { int x3 = 3; x5 = x3; } else |
| | else | { int x4 = 4; x5 = x4; } |
| | x = 4; | if (x5 == 2) return ‘A’; |
| | if (x == 2) return ‘A’; | if (x5 == 3) return ‘B’; |
| | if (x == 3) return ‘B’; | return ‘C’; |
| | return ‘C’; | |

In this example, the meaning of the original code depends on understanding that when the computer processor executes the instruction, “if (x==2) return ‘A’;” in the original code that the data flow does not flow to the expression, “return ‘A’,” because the x value of 2 is overwritten with a different value on both branches of the if-statement preceding this instruction. Accordingly, the signal amplifier 108 can amplify this data flow signal by giving each instruction assigning an “x” value, a unique variable name. Thus, instead of repeated references to the x variable in the original code, the amplified code includes variables, x2, x3, x4, and x5. In this way, the signal amplifier 108 makes it easier for the machine learning model 104 to determine that the expression, “if (x==2),” evaluates to false regardless of the data flow through the preceding if-statement.

As stated previously, TABLES 1 through 4 merely represent examples of amplifying source code for some potential signal categories. According to some embodiments of the present disclosure, the signal amplifier 108 can use different techniques to amplify the signal categories described herein. Additionally, the signal amplifier 108 can amplify additional other signal categories, which may vary as described above.

The code re-writer 118 can be configured as described above by adapting techniques similar to various existing code rewrite tools. Some examples of code rewrite tools include optimizations performed inside of compilers, refactorings performed inside of integrated development environments (IDES), and the like.

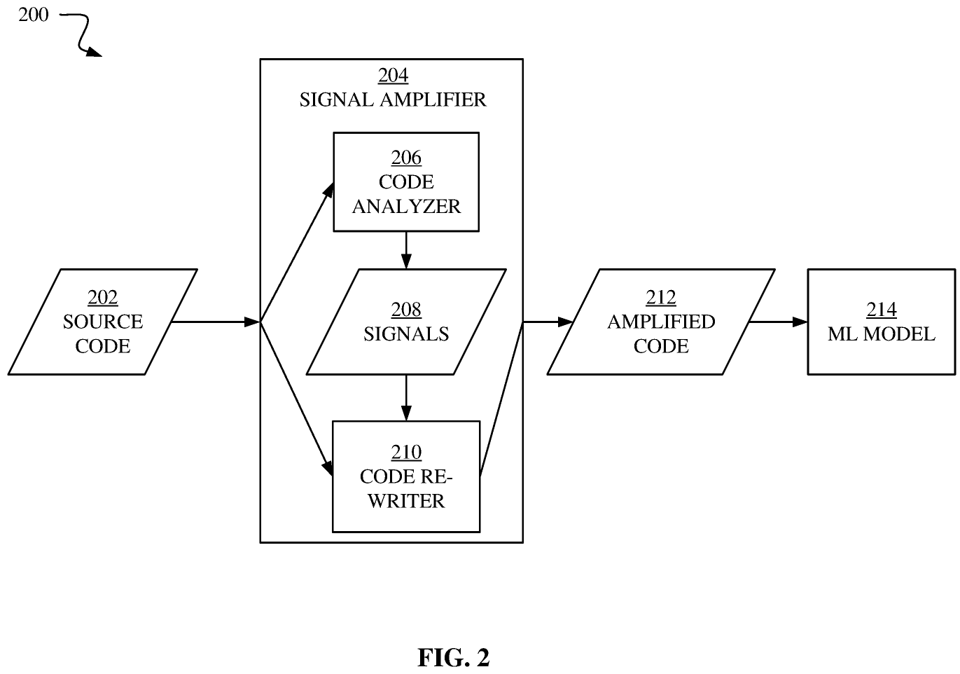

FIG. 2 is a data flow diagram of an example process 200 for amplifying source code signals for machine learning, in accordance with some embodiments of the present disclosure. In the process 200, source code 202 is input to a signal amplifier 204. The source code 202 and signal amplifier 204 can be respectively similar to the source code 106 and signal amplifier 108 described with respect to FIG. 1.

More specifically, the source code 202 can be input to a code analyzer 206. The code analyzer 206 can be similar to the code analyzer 116. Accordingly, the code analyzer 206 can extract signals 208 from the source code 202. The signals 208 can be similar to the code signals 110. Additionally, the signals 208 can be input to code re-writer 210, which can be similar to the code re-writer 118. Accordingly, the code re-writer 210 can generate amplified code 212. The amplified code 212 can be similar to the amplified code 112.

Further, the amplified code 212 can be input to a machine learning (ML) model 214. The ML model 214 can be similar to the machine learning model 104. The ML model 214 can use the amplified code 212 for training on a source code related task. Additionally, the ML model 214 can score the amplified source code 112 in the performance of the trained task.

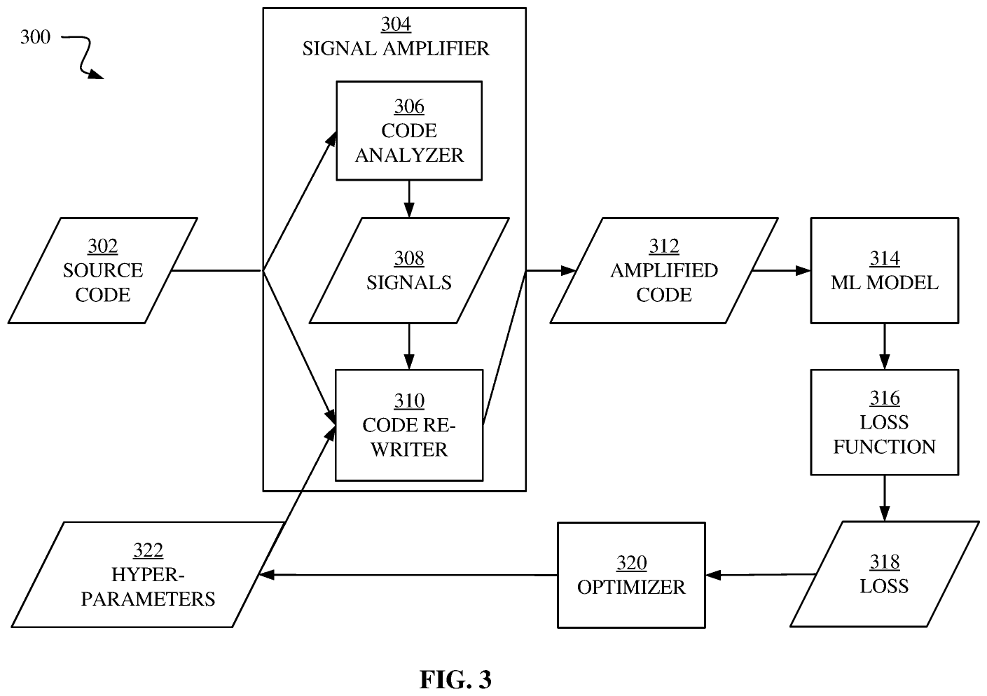

FIG. 3 is a data flow diagram for an example system 300 for amplifying source code signals with automatic tuning, in accordance with some embodiments of the present disclosure. The system includes source code 302, signal amplifier 304, code analyzer 306, signals 308, code re-writer 310, amplified code 312, and ML model 314, which are respectively similar to source code 202, signal amplifier 204, code analyzer 206, signals 208, code re-writer 210, amplified code 212, and ML model 214 described with respect to FIG. 2.

Additionally, the system 300 includes a loss function 316, loss 318, optimizer 320, and hyperparameters 322. The system 300 can use these additional features to automatically improve the performance of the machine learning model 314. For example, while there is a variety of code signals in the source code 302 (e.g., syntax, scope, types, and data flow), some of these amplifications may be more or less beneficial for any particular downstream ML model, e.g., ML model 314. Accordingly, in some embodiments of the present disclosure, the signal amplifier 108 can selectively amplify the code signals 110 for pre-determined hyperparameters 322. The hyperparameters 322 can identify the signal categories that are comparatively more beneficial for the ML model's classification task. For example, a machine learning model that benefits from data flow signals more than syntax signals may identify data flow signals in the hyperparameters 322. Accordingly, the signal amplifier 108 can generate amplified code 112 for data flow signals, but not for syntax signals or other signals.

According to some embodiments of the present disclosure, the ML model 314 provides metrics to the loss function 316, which evaluates the ML model 314. The loss function 316 can determine the loss 318, which is input to the optimizer 320. The loss function 316 can evaluate the performance of the ML model 314 and determine the loss 318. The loss 318 can identify statistics about the quality of prediction tasks.

The optimizer 320 can be a hyperparameter optimization (HPO) optimizer. An HPO optimizer can use grid search, randomized search, Bayesian optimization, and the like to identify candidate hyperparameters of the code rewriter 310. The amplified code 312 can be fed into another trial of the ML model 314, completing a loop trial. After multiple such trials, the optimizer 320 can select the hyperparameters 322 that mathematically minimize the loss.

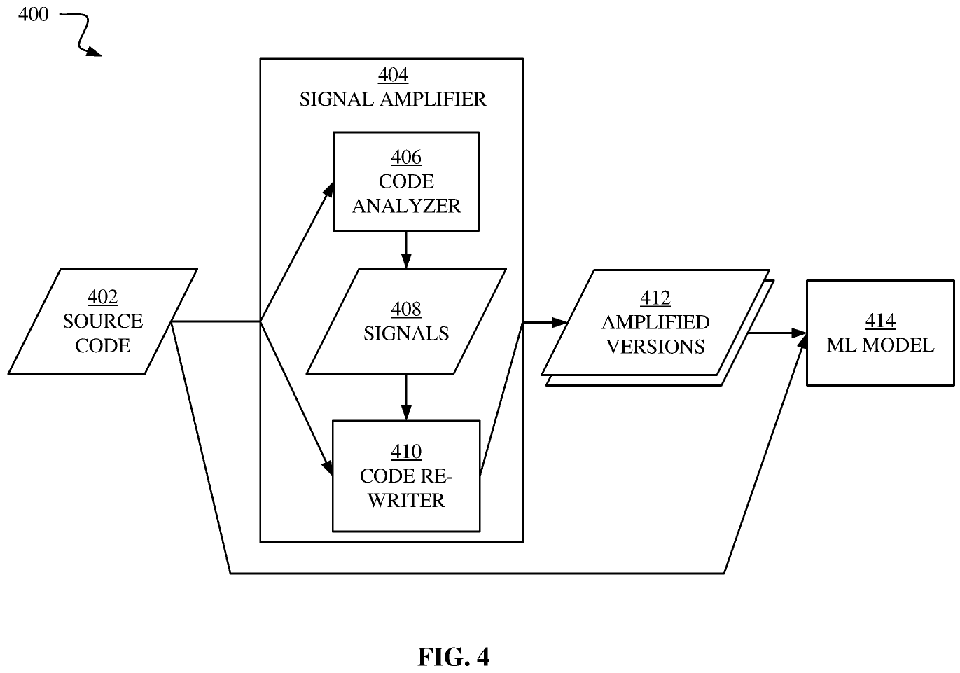

FIG. 4 is a data flow diagram of an example system 400 for amplifying source code signals for machine learning, in accordance with some embodiments of the present disclosure. The system includes source code 402, signal amplifier 404, code analyzer 406, signals 408, code re-writer 410, amplified versions 412, and ML model 414, which are respectively similar to source code 202, signal amplifier 204, code analyzer 206, signals 208, code re-writer 210, amplified code 212, and ML model 214 described with respect to FIG. 2. The amplified versions 412 can be used for data augmentation. Data augmentation can create additional training data, which in turn can help the ML model 414 generalize better. For example, the amplified versions 412 can include multiple functionally equivalent variants of the source code 402. Functionally equivalent means that the amplified versions 412 of the source code 402 behave the same as the source code 402. Thus, if the ML model 414 is accurate, the predictions for each of the source code 402 and amplified versions 412 are the same. This can be true even when viewed as a sequence of raw characters, the code looks different (such as adding parentheses or renaming variables). In other words, while the amplified versions 412 and the source code 402 may look different, they behave the same. Thus, if the ML model 414 does not make the same predictions for them, there is an issue with the ML model 414. Accordingly, the source code 402 and amplified versions 412 can be combined to increase the amount of training data for the ML model 414. In this way, the signal amplifier 404 can improve the efficiency of ML model performance.

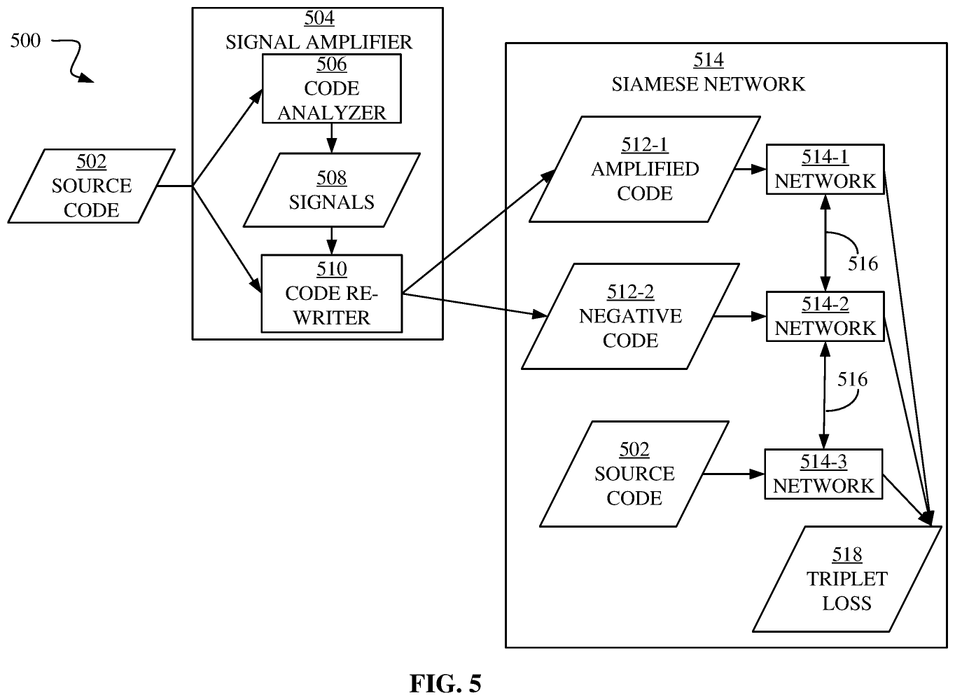

FIG. 5 is a data flow diagram of an example system for amplifying source code signals for machine learning, in accordance with some embodiments of the present disclosure. The system includes source code 502, signal amplifier 504, code analyzer 506, signals 508, code re-writer 510, and amplified code 512-1, which are respectively similar to source code 202, signal amplifier 204, code analyzer 206, signals 208, code re-writer 210, and amplified code 212, described with respect to FIG. 2. Additionally, the system 500 includes negative code 512-2 and a Siamese network 514. The Siamese network 514 can be an artificial neural network that uses shared weights while working on the same model, but on two different inputs to compute comparable outputs. Accordingly, the lines 516 represent the shared weights between the networks 514-1, 514-2, 514-3 processing the respective inputs, amplified code 512-1, negative code 512-2, and source code 502. The triplet loss 518 can give a relatively high loss when the model's internal representation of the source code 502 is similar to that of the negative code 512-2, or when the model's internal representation of the source code 502 is dissimilar to that of the amplified code 512-1, thus guiding the ML model towards a better representation of the source code 502. In this way, the Siamese network 514 can use triplet loss 518 to train an ML model that performs its original task efficiently, and less susceptible to mistakes on adversarial examples.

In the system 500, the amplified code 512-1 and negative code 512-2 provide positive and negative variants of the source code 502. Thus, in addition to generating amplified rewritten code, the code amplifier 504 can also generate adversarial rewritten code, i.e., the negative code 512-2. Here, adversarial means that the negative code 512-2 behaves different from the source code 502, even though the sequence of raw characters can be almost the same. Such adversarial code might fool an ML model to make the wrong predictions if the ML model does not pay attention to relatively minor, but adversarial, changes in the code.

Below, TABLES 5 through 8 include examples of input and negative Java source code for respective signal categories: syntax, scope, types, and data flow. Each of TABLES 5 through 8 include columns labeled, signal category, original, and negative. The original and negative columns reference respective source code 502 and negative code 512-2, e.g., before and after examples of Java source code. While the given examples are in the Java programming language, the signal amplifier 504 can amplify code signals in various other programming languages.

TABLE 5

| SIGNAL | | |
|---|---|---|
| CATEGORY | ORIGINAL | NEGATIVE |
| SYNTAX | if (x ∥ y == false) | if ((x ∥ y) == false) |
| | return ‘A’; | return ‘A’; |
| | return ‘B’; | return ‘B’; |

In TABLE 5, the signal category is syntax. Thus, the original code can be relevant to one or more rules of syntax. As stated previously, the meaning of the expression “(x∥y==false),” in the original code, depends on the syntax of operator precedence. However, instead of amplifying the accurate operator precedence, the negative code changes the operator precedence by placing parentheses in the wrong place, i.e., “(x∥y).” In this way, the signal amplifier 504 makes it easier for the machine learning model to identify adversarial examples of source code 502.

In TABLE 6, the signal category is scope. As stated previously, scope can define a functional state within which a variable can be referenced.

TABLE 6

| SIGNAL | | |
|---|---|---|
| CATEGORY | ORIGINAL | NEGATIVE |
| SCOPE | x = 5; | x = 5; |
| | { int x = 10; } | int x = 10; |
| | if (x == 5) return ‘A’; | if (x == 5) return ‘A’; |
| | return ‘B’; | return ‘B’; |

As shown, the negative code removes curly braces from the definition of the integer variable, x. Removing the curly braces changes the scopes and how the variable, x, is bound.

In TABLE 7, the signal category is types. As stated previously, the types can define what type of data a variable holds, and how a computer processor handles operations on this data.

TABLE 7

| SIGNAL | | |
|---|---|---|
| CATEGORY | ORIGINAL | NEGATIVE |
| TYPES | var x = 3.0; | var x = 3.0; |
| | if (x / 2 == 1.5) | if ((int)x / 2 == 1.5) |
| | return ‘A’; | return ‘A’; |
| | return ‘B’; | return ‘B’; |

As shown in TABLE 7, the negative code adds a cast to “int” for the variable, x. This change impacts the behavior of the division operation, such that the result is rounded down to an integer value.

In TABLE 8, the signal category is data flow. As stated previously, the data flow can represent how data values propagate between variables and expressions during program execution.

TABLE 4

| SIGNAL | | |
|---|---|---|
| CATEGORY | ORIGINAL | NEGATIVE |
| DATA FLOW | int x = 2; | int x2 = 2; |
| | if (flag) | if (flag) |
| | x = 3; | { int x3 = 3; } |
| | else | else |
| | x = 4; | { int x4 = 4; } |
| | if (x == 2) return ‘A’; | if (x2 == 2) return ‘A’; |
| | if (x == 3) return ‘B’; | if (x2 == 3) return ‘B’; |
| | return ‘C’; | return ‘C’; |

As shown in TABLE 8, the negative code renames variables to change the data flow from the original code. This change in data flow results in the value “2” for variable, x, flowing to the comparison instruction, “if (x2==2),” which provides a true result and incorrectly returns, “A,” instead of, “B,” or, “C.”

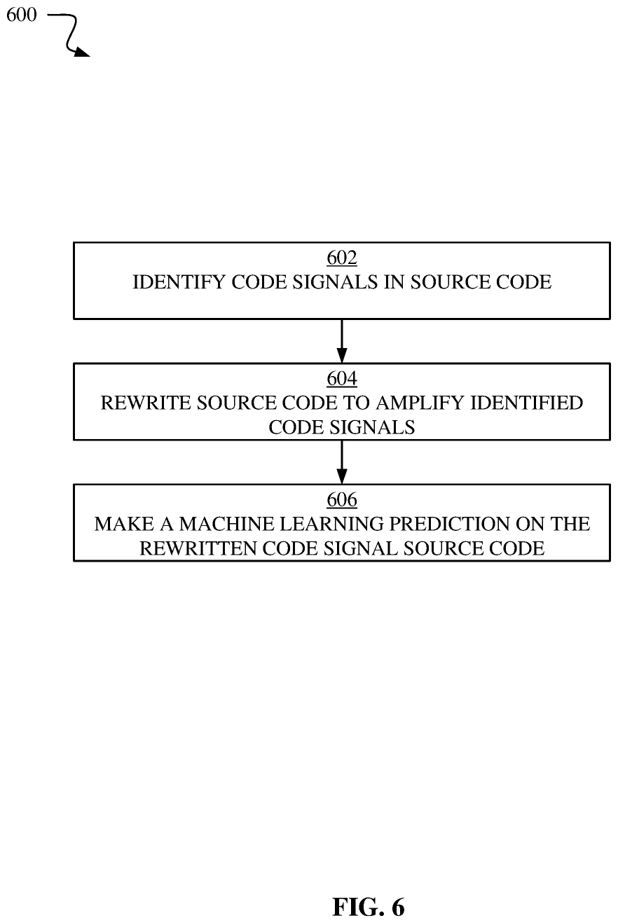

FIG. 6 is a process flow diagram of an example method for amplifying source code signals for machine learning, in accordance with some embodiments of the present disclosure. The signal amplifier 108 and machine learning model 104, described with respect to FIG. 1 can perform the method 600 in accordance with some embodiments of the present disclosure.

At operation 602, the signal amplifier 108 can identify code signals in source code. The code signals can be the code signals 110 in source code 106. As stated previously, code signals 110 can be source code that is relevant to a specific context of programming languages.

At operation 604, the signal amplifier 108 can rewrite the source code 106 to amplify the identified code signals 110. As stated previously, the signal amplifier 108 can include a code analyzer 116 that can identify the code signals 110. Additionally, the signal amplifier 108 can include the code re-writer 118 that generates amplified code 112 having amplified signals 114.

At operation 606, the machine learning model 104 can make a machine learning prediction on the amplified code 112. As stated previously, the amplified code 112 can include amplified signals 114 that make it easier for the machine learning model 104 to identify the signals and perform its prediction. Accordingly, the machine learning model 104 may use the amplified code 112 to perform its task.

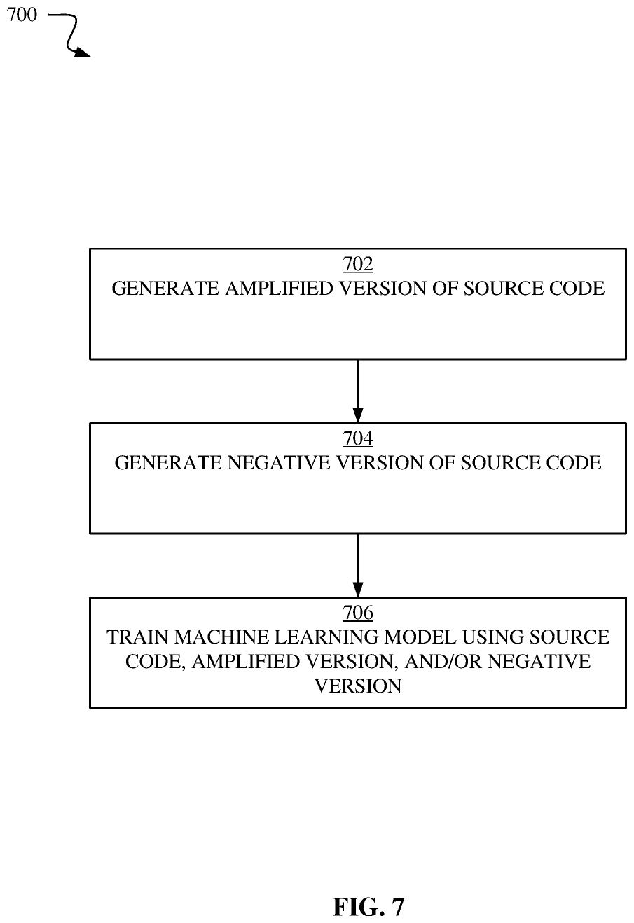

FIG. 7 is a process flow diagram of an example method for amplifying source code signals for machine learning, in accordance with some embodiments of the present disclosure. The signal amplifier 108 and machine learning model 104, described with respect to FIG. 1 can perform the method 700 in accordance with some embodiments of the present disclosure.

At operation 702, the signal amplifier 108 can generate an amplified version of the source code 106. The amplified version can include the amplified code 112, for example, which is functionally equivalent to the source code 106, but having amplified signals 114.

At operation 704, the signal amplifier 108 can generate a negative version of the source code 106. The negative version can include the negative code 512-2, for example, which is textually similar to the source code 106, but functionally different.

At operation 706, the machine learning model 104 can train using the source code 106, amplified code 112, and/or negative code 512-2. Training in this way can enable the machine learning model 104 to distinguish between textually similar, but functionally different code.

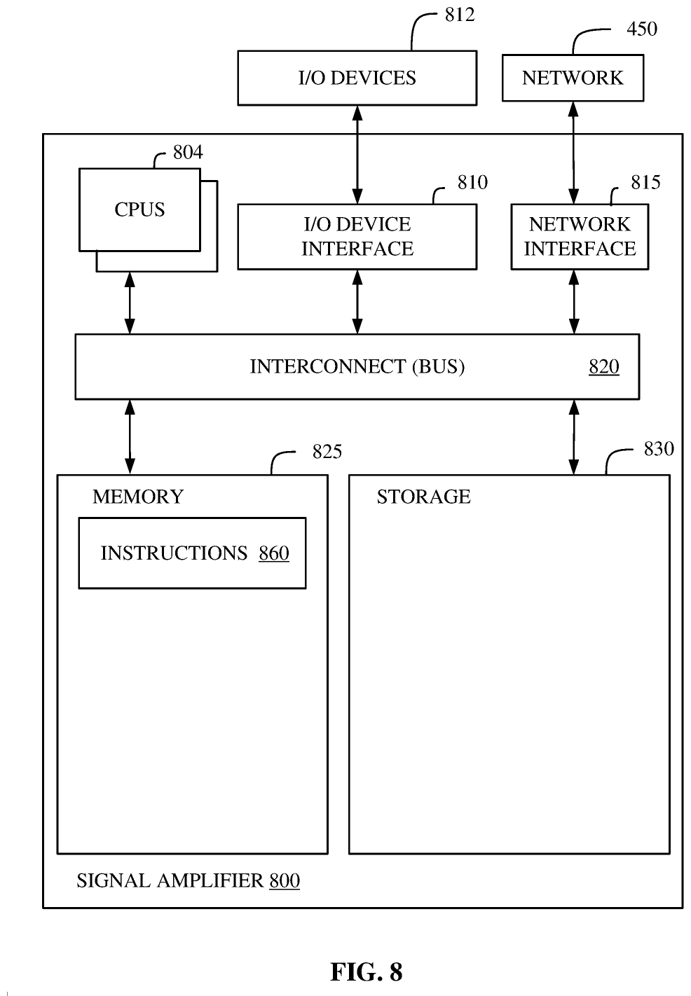

FIG. 8 is a block diagram of an example signal amplifier 800, in accordance with some embodiments of the present disclosure. In various embodiments, the signal amplifier 800 is similar to the signal amplifier 116 and can perform the methods described in FIGS. 7-8 and/or the functionality discussed in FIGS. 1-6. In some embodiments, the signal amplifier 800 provides instructions for the aforementioned methods and/or functionalities to a client machine such that the client machine executes the method, or a portion of the method, based on the instructions provided by the signal amplifier 800. In some embodiments, the signal amplifier 800 comprises software executing on hardware incorporated into a plurality of devices.

The signal amplifier 800 includes a memory 825, storage 830, an interconnect (e.g., BUS) 820, one or more CPUs 805 (also referred to as processors 805 herein), an I/O device interface 810, I/O devices 812, and a network interface 815.

Each CPU 805 retrieves and executes programming instructions stored in the memory 825 or the storage 830. The interconnect 820 is used to move data, such as programming instructions, between the CPUs 805, I/O device interface 810, storage 830, network interface 815, and memory 825. The interconnect 820 can be implemented using one or more busses. The CPUs 805 can be a single CPU, multiple CPUs, or a single CPU having multiple processing cores in various embodiments. In some embodiments, a CPU 805 can be a digital signal processor (DSP). In some embodiments, CPU 805 includes one or more 3D integrated circuits (3DICs) (e.g., 3D wafer-level packaging (3DWLP), 3D interposer based integration, 3D stacked ICs (3D-SICs), monolithic 3D ICs, 3D heterogeneous integration, 3D system in package (3DSiP), and/or package on package (PoP) CPU configurations). Memory 825 is generally included to be representative of a random access memory (e.g., static random access memory (SRAM), dynamic random access memory (DRAM), or Flash). The storage 830 is generally included to be representative of a non-volatile memory, such as a hard disk drive, solid state device (SSD), removable memory cards, optical storage, and/or flash memory devices. Additionally, the storage 830 can include storage area-network (SAN) devices, the cloud, or other devices connected to the signal amplifier 800 via the I/O device interface 810 or to a network 850 via the network interface 815.

In some embodiments, the memory 825 stores instructions 860. However, in various embodiments, the instructions 860 are stored partially in memory 825 and partially in storage 830, or they are stored entirely in memory 825 or entirely in storage 830, or they are accessed over a network 850 via the network interface 815.

Instructions 860 can be processor-executable instructions for performing any portion of, or all, any of the methods described in FIGS. 7-8 and/or the functionality discussed in FIGS. 1-6.

In various embodiments, the I/O devices 812 include an interface capable of presenting information and receiving input. For example, I/O devices 812 can present information to a listener interacting with signal amplifier 800 and receive input from the listener.

The signal amplifier 800 is connected to the network 850 via the network interface 815. Network 850 can comprise a physical, wireless, cellular, or different network.

In some embodiments, the signal amplifier 800 can be a multi-user mainframe computer system, a single-user system, or a server computer or similar device that has little or no direct user interface but receives requests from other computer systems (clients). Further, in some embodiments, the signal amplifier 800 can be implemented as a desktop computer, portable computer, laptop or notebook computer, tablet computer, pocket computer, telephone, smart phone, network switches or routers, or any other appropriate type of electronic device.

It is noted that FIG. 8 is intended to depict the representative major components of an exemplary signal amplifier 800. In some embodiments, however, individual components can have greater or lesser complexity than as represented in FIG. 8, components other than or in addition to those shown in FIG. 8 can be present, and the number, type, and configuration of such components can vary.

Although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model can include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It can be managed by the organization or a third-party and can exist on-premises or off-premises.

Community cloud: the cloud infrastructure is shared by several organizations and supports a specific community that has shared concerns (e.g., mission, security requirements, policy, and compliance considerations). It can be managed by the organizations or a third-party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

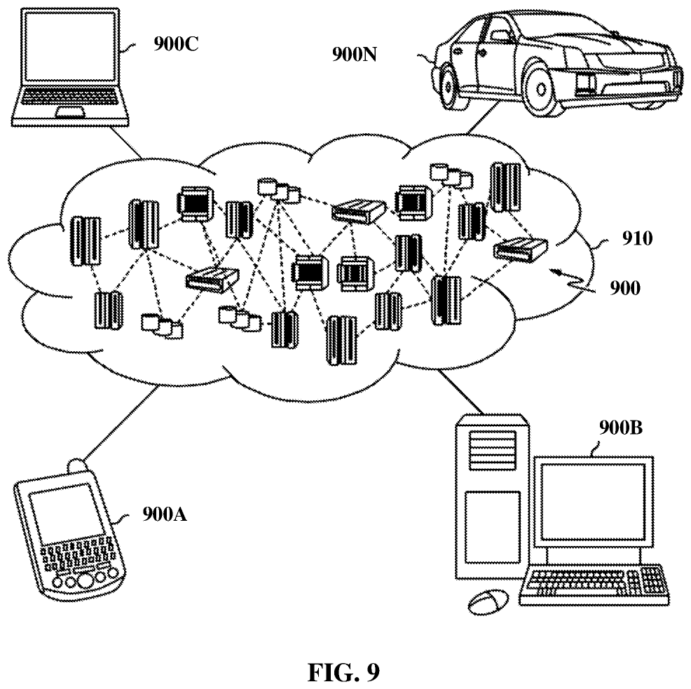

FIG. 9 is a cloud computing environment 910, according to some embodiments of the present disclosure. As shown, cloud computing environment 910 includes one or more cloud computing nodes 900. The cloud computing nodes 900 can perform the method described in FIGS. 7-8 and/or the functionality discussed in FIGS. 1-6. Additionally, cloud computing nodes 900 can communicate with local computing devices used by cloud consumers, such as, for example, personal digital assistant (PDA) or cellular telephone 900A, desktop computer 900B, laptop computer 900C, and/or automobile computer system 900N. Further, the cloud computing nodes 900 can communicate with one another. The cloud computing nodes 900 can also be grouped (not shown) physically or virtually, in one or more networks, such as Private, Community, Public, or Hybrid clouds as described hereinabove, or a combination thereof. This allows cloud computing environment 910 to offer infrastructure, platforms and/or software as services for which a cloud consumer does not need to maintain resources on a local computing device. It is understood that the types of computing devices 900A-N shown in FIG. 9 are intended to be illustrative only and that computing nodes 900 and cloud computing environment 910 can communicate with any type of computerized device over any type of network and/or network addressable connection (e.g., using a web browser).

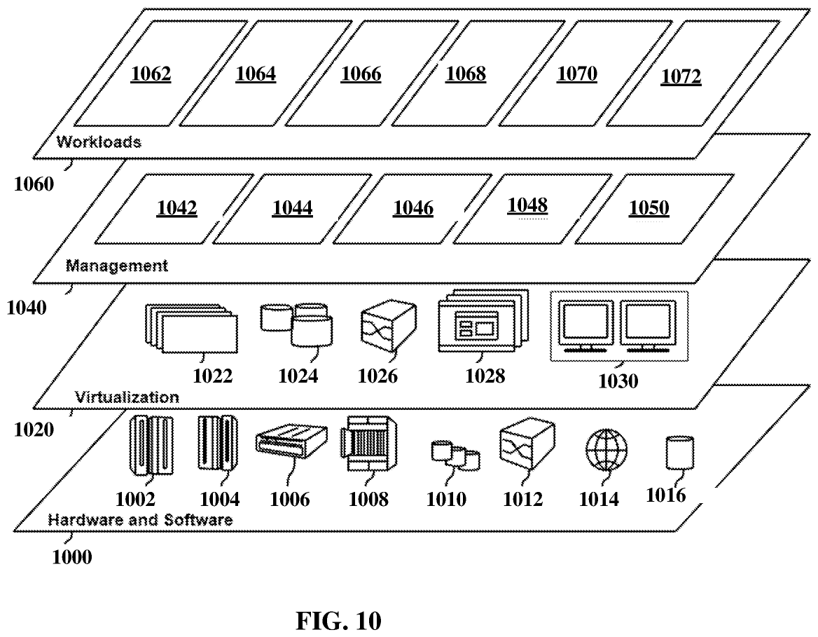

FIG. 10 is a set of functional abstraction model layers provided by cloud computing environment 910 (FIG. 9), according to some embodiments of the present disclosure. It should be understood in advance that the components, layers, and functions shown in FIG. 10 are intended to be illustrative only and embodiments of the disclosure are not limited thereto. As depicted below, the following layers and corresponding functions are provided.

Hardware and software layer 1000 includes hardware and software components. Examples of hardware components include: mainframes 1002; RISC (Reduced Instruction Set Computer) architecture based servers 1004; servers 1006; blade servers 1008; storage devices 1010; and networks and networking components 1012. In some embodiments, software components include network application server software 1014 and database software 1016.

Virtualization layer 1020 provides an abstraction layer from which the following examples of virtual entities can be provided: virtual servers 1022; virtual storage 1024; virtual networks 1026, including virtual private networks; virtual applications and operating systems 1028; and virtual clients 1030.

In one example, management layer 1040 can provide the functions described below. Resource provisioning 1042 provides dynamic procurement of computing resources and other resources that are utilized to perform tasks within the cloud computing environment. Metering and Pricing 1044 provide cost tracking as resources are utilized within the cloud computing environment, and billing or invoicing for consumption of these resources. In one example, these resources can include application software licenses. Security provides identity verification for cloud consumers and tasks, as well as protection for data and other resources. User portal 1046 provides access to the cloud computing environment for consumers and system administrators. Service level management 1048 provides cloud computing resource allocation and management such that required service levels are met. Service level management 1048 can allocate suitable processing power and memory to process static sensor data. Service Level Agreement (SLA) planning and fulfillment 1050 provide pre-arrangement for, and procurement of, cloud computing resources for which a future requirement is anticipated in accordance with an SLA.

Workloads layer 1060 provides examples of functionality for which the cloud computing environment can be utilized. Examples of workloads and functions which can be provided from this layer include: mapping and navigation 1062; software development and lifecycle management 1064; virtual classroom education delivery 1066; data analytics processing 1068; transaction processing 1070; and signal amplifier 1072.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, Java, Python or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A non-limiting list of examples are provided hereinafter to demonstrate some aspects of the present disclosure. Example 1 is a computer-implemented method. The method includes identifying one or more source code signals in a source code; generating an amplified code based on the identified signals and the source code, wherein the amplified code is functionally equivalent to the source code, and wherein the amplified code comprises one or more amplified signals; and providing the amplified code for a machine learning model that is trained to perform a source code relevant task.

Example 2 includes the method of example 1, including or excluding optional features. In this example, the method includes determining a loss of the machine learning model using a loss function; selecting one or more source code signal categories for amplification; selecting one or more of the source code signal categories for de-amplification; and identifying the one or more source code signals based on the selected source code signal categories.

Example 3 includes the method of any one of examples 1 to 2, including or excluding optional features. In this example, the method includes where the source code signals comprise: syntax; scope; data flow; and types.

Example 4 includes the method of any one of examples 1 to 3, including or excluding optional features. In this example, generating the amplified code comprises performing a refactoring.

Example 5 includes the method of any one of examples 1 to 4, including or excluding optional features. In this example, generating the amplified code comprises performing a compiler optimization.

Example 6 includes the method of any one of examples 1 to 5, including or excluding optional features. In this example, the method includes generating a plurality of amplified versions of the source code; and training the machine learning model using the source code and the amplified versions.

Example 7 includes the method of any one of examples 1 to 6, including or excluding optional features. In this example, the method includes generating one or more negative code based on the source code; and training the machine learning model using the source code and the negative code.

Example 8 includes the method of any one of examples 1 to 7, including or excluding optional features. In this example, the amplified code comprises one of: training data; test data; and production traffic.

Example 9 is a computer program product. The computer program product includes identifying one or more source code signals in a source code; generating a plurality of amplified versions of the source code based on the identified signals and the source code, wherein the amplified versions of the source code are functionally equivalent to the source code, and wherein the amplified versions of the source code comprise one or more amplified signals; and training a machine learning model to perform a source code relevant task using the source code and the amplified versions of the source code.

Example 10 includes the computer program product of example 9, including or excluding optional features. In this example, the computer program product includes making a prediction about an additional source code using the trained machine learning model; determining a loss of the machine learning model using a loss function; selecting one or more source code signal categories for amplification; selecting one or more of the source code signal categories for de-amplification; and identifying the one or more source code signals based on the selected source code signal categories.

Example 11 includes the computer program product of any one of examples 9 to 10, including or excluding optional features. In this example, the computer program product includes where the source code signals comprise: syntax; scope; data flow; and types.

Example 12 includes the computer program product of any one of examples 9 to 11, including or excluding optional features. In this example, generating the amplified versions comprises performing a refactoring.

Example 13 includes the computer program product of any one of examples 9 to 12, including or excluding optional features. In this example, generating the amplified versions comprises performing a compiler optimization.

Example 14 includes the computer program product of any one of examples 9 to 13, including or excluding optional features. In this example, the computer program product includes generating one or more negative versions based on the source code; and training the machine learning model using the source code and the negative versions.

Example 15 includes the computer program product of any one of examples 9 to 14, including or excluding optional features. In this example, the computer program product includes the amplified versions comprise one of: training data; test data; and production traffic.

Example 16 is a system. The system includes one or more computer processing circuits; and one or more computer-readable storage media storing program instructions which, when executed by the one or more computer processing circuits, are configured to cause the one or more computer processing circuits to perform a method comprising: identifying one or more source code signals in a source code; generating a plurality of amplified versions of the source code based on the identified signals and the source code, wherein the amplified versions of the source code are functionally equivalent to the source code, and wherein the amplified versions of the source code comprise one or more amplified signals; generating one or more negative versions based on the source code; and training a machine learning model to perform a source code relevant task using the source code, the amplified versions, and the negative versions.

Example 17 includes the system of example 16, including or excluding optional features. In this example, the system includes making a prediction about an additional source code using the trained machine learning model; determining a loss of the machine learning model using a loss function; selecting one or more source code signal categories for amplification; selecting one or more of the source code signal categories for de-amplification; and identifying the one or more source code signals based on the selected source code signal categories.

Example 18 includes the system of any one of examples 16 to 17, including or excluding optional features. In this example, the system includes where the source code signals comprise: syntax; scope; data flow; and types.

Example 19 includes the system of any one of examples 16 to 18, including or excluding optional features. In this example, the system includes generating the amplified versions and the negative versions comprise performing a refactoring.

Example 20 includes the system of any one of examples 16 to 19, including or excluding optional features. In this example, generating the amplified versions and the negative versions comprise performing a compiler optimization.

What is claimed is:

1. A computer-implemented method, comprising:
identifying one or more source code signals in a source code;
generating an amplified code based on the identified signals and the source code, wherein the amplified code is functionally equivalent to the source code, and wherein the amplified code comprises one or more amplified signals; and
providing the amplified code for a machine learning model that is trained to perform a source code relevant task.

2. The method of claim 1, further comprising:
determining a loss of the machine learning model using a loss function;
selecting one or more source code signal categories for amplification;
selecting one or more of the source code signal categories for de-amplification; and
identifying the one or more source code signals based on the selected source code signal categories.

3. The method of claim 1, where the source code signals comprise:
syntax;
scope;
data flow; and
types.

4. The method of claim 1, wherein generating the amplified code comprises performing a refactoring.

5. The method of claim 1, wherein generating the amplified code comprises performing a compiler optimization.

6. The method of claim 1, further comprising:
generating a plurality of amplified versions of the source code; and
training the machine learning model using the source code and the amplified versions.

7. The method of claim 1, further comprising:
generating one or more negative code based on the source code; and
training the machine learning model using the source code and the negative code.

8. The method of claim 1, the amplified code comprises one of:
training data;
test data; and
production traffic.

9. A computer program product comprising one or more computer readable storage media, and program instructions collectively stored on the one or more computer readable storage media, the program instructions comprising instructions configured to cause one or more processors to perform a method comprising:
identifying one or more source code signals in a source code;
generating a plurality of amplified versions of the source code based on the identified signals and the source code, wherein the amplified versions of the source code are functionally equivalent to the source code, and wherein the amplified versions of the source code comprise one or more amplified signals; and
training a machine learning model to perform a source code relevant task using the source code and the amplified versions of the source code.

10. The computer program product of claim 9, the method further comprising:
making a prediction about an additional source code using the trained machine learning model;
determining a loss of the machine learning model using a loss function;
selecting one or more source code signal categories for amplification;
selecting one or more of the source code signal categories for de-amplification; and
identifying the one or more source code signals based on the selected source code signal categories.

11. The computer program product of claim 9, where the source code signals comprise:
syntax;
scope;
data flow; and
types.

12. The computer program product of claim 9, wherein generating the amplified versions comprises performing a refactoring.

13. The computer program product of claim 9, wherein generating the amplified versions comprises performing a compiler optimization.

14. The computer program product of claim 9, the method further comprising:
generating one or more negative versions based on the source code; and
training the machine learning model using the source code and the negative versions.

15. The computer program product of claim 9, the amplified versions comprise one of:
training data;
test data; and
production traffic.

16. A system comprising:
one or more computer processing circuits; and
one or more computer-readable storage media storing program instructions which, when executed by the one or more computer processing circuits, are configured to cause the one or more computer processing circuits to perform a method comprising:
identifying one or more source code signals in a source code;
generating a plurality of amplified versions of the source code based on the identified signals and the source code, wherein the amplified versions of the source code are functionally equivalent to the source code, and wherein the amplified versions of the source code comprise one or more amplified signals;
generating one or more negative versions based on the source code; and
training a machine learning model to perform a source code relevant task using the source code, the amplified versions, and the negative versions.

17. The system of claim 16, the method further comprising:
making a prediction about an additional source code using the trained machine learning model;
determining a loss of the machine learning model using a loss function;
selecting one or more source code signal categories for amplification;
selecting one or more of the source code signal categories for de-amplification; and
identifying the one or more source code signals based on the selected source code signal categories.

18. The system of claim 16, where the source code signals comprise:
syntax;
scope;
data flow; and
types.

19. The system of claim 16, generating the amplified versions and the negative versions comprise performing a refactoring.

20. The system of claim 16, wherein generating the amplified versions and the negative versions comprise performing a compiler optimization.
